(19) United States
(12) Patent Application Publication
(10) Pub. No.: US 2002/0151324 A1
(43) Pub. Date: Oct. 17, 2002

(54) Apparatus for recording and reproducing audio data

(75) Inventor: Kaoru Tatsumi, Sagamihara-shi (JP)

Correspondence Address: Finnegan, Henderson, Farabow,, Garrett & Dunner, L.L.P., 1300 I Street, N.W., Washington, DC, 20005-3315, US

(73) Assignee: KABUSHIKI KAISHA TOSHIBA

(21) Appl. No.: 10/122,355

(22) Filed: Apr. 16, 2002

(30) Foreign Application Priority Data
Apr. 17, 2001 (JP) 2001-118248

(51) Int. Cl. H04B 1/38

(52) U.S. Cl. 455/550; 455/412

(57) ABSTRACT

An apparatus for recording and reproducing received and transmission audio signal data comprises a memory and a decoding unit. The memory synchronously stores received and transmission signal data in compressed form in different areas stores. The decoding unit decodes the received and transmission signals data retrieved from the memory, and adjusts reproducing timings of the received and transmission signal data.

### CROSS-REFERENCE TO RELATED APPLICATIONS

This application is based upon and claims the benefit of priority from the prior Japanese Patent Application No. 2001-118248, filed Apr. 17, 2001, the entire contents of which are incorporated herein by reference.

### BACKGROUND OF THE INVENTION

1. Field of the Invention

The present invention relates to an audio-data recording/reproducing apparatus for recording or reproducing received/transmission audio data, and more particularly, to an audio-data recording/reproducing apparatus capable of synchronously recording and reproducing received and transmission speech.

2. Description of the Related Art

From here onwards, the terms “voice” and “speech” are used interchangeably.

A digital mobile radio communication apparatus has many functions, one of which is recording speech during a call. In the prior art, only the received speech can be recorded using the recording function.

This is because the conventional mobile radio communication apparatus incorporates only decoder for reproducing received or transmission speech, and then the conventional apparatus can only reproduce received or transmission speech. Accordingly, received or transmission speech cannot be simultaneously recorded. In general, only a received voice can be recorded.

However, in order to confirm how the user themselves responded to the received speech, it is necessary to simultaneously or synchronously reproduce received and transmission speech. To this end, a function for simultaneously or synchronously recording and reproducing received and transmission speech is required.

It is possible to simply use a further decoder. However, the addition of another decoder increases the circuit scale and hence the manufacturing cost. This is very disadvantageous for manufacturing a commercial mobile radio communication apparatus capable of synchronously recording/reproducing transmission and received speech. Japanese Patent Application Publication No. 10-271061 discloses a mobile radio communication apparatus capable of reproducing both received and transmission speech, using only one decoder. In this apparatus, received and transmission audio signals data are once stored in a memory as the form of PCM (Pulse-Code Modulation) system data, and the stored data is output and reproduced.

Since, however, the amount of data handled in a PCM system is large, the amount of data requires a large memory capacity. Therefore, a mobile radio communication apparatus that only has a small memory cannot record PCM data for a long time.

### BRIEF SUMMARY OF THE INVENTION

The present invention has been developed in light of the above-described problems, and aims to provide an audio-data recording/reproducing apparatus, for use in a mobile radio communication apparatus, which can record received and transmission audio data as compressed data, and synchronously reproduce the compressed data using one decoder.

According to an aspect of the invention, there is provided an apparatus for recording and reproducing audio signal data used in a mobile radio communication apparatus for communicating with a base station, comprising:

a memory configured to synchronously store received and transmission signal data in compressed form in different areas; and

a decoding unit configured to decode the received and transmission signals data retrieved from the memory, and adjust reproducing timings of the received and transmission signal data.

According to another aspect of the invention, there is provided an apparatus for recording and reproducing audio signal data used in a mobile radio communication apparatus for communicating with a base station, comprising:

memory means for synchronously storing received and transmission signal data in compressed form in different areas; and

decoding means for decoding the received and transmission signals data retrieved from the memory, and adjusting reproducing timings of the received and transmission signal data.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating electrical connections in an audio-data recording/reproducing apparatus according to a first embodiment of the invention;

FIG. 2 is a view schematically showing the memory area of a memory, which is divided into an area for encoded received voice data, a user area, and an area for encoded transmission voice data;

FIG. 3 is a block diagram illustrating electrical connections in a decoding circuit appearing in FIG. 1;

FIG. 4 is a view illustrating a state in which encoded received and transmission audio signals data are decoded by the decoding circuit appearing in FIG. 1, and then the decoded signals data are added;

FIG. 5 is a block diagram illustrating electrical connections in the decoder appearing in FIG. 1, and electrical connections between the decoding circuit and the counter of a control section;

FIG. 6 is a flowchart useful in explaining the operation of the decoding circuit of FIG. 3 to decode encoded received and transmission audio signals; and

FIG. 7 is a block diagram illustrating electrical connections of a decoding circuit, digital/analog converter, amplifier and loudspeaker incorporated in an audio-data recording/reproducing apparatus according to a second embodiment of the invention.

### DETAILED DESCRIPTION OF THE INVENTION

Audio-data recording/reproducing apparatuses according to the embodiments of the invention will be described with reference to the accompanying drawings.

In the embodiments, received and transmission audio signals data are encoded and stored in a memory, with their time information preserved, i.e., in a synchronized state. In other words, the audio signals data are stored not as PCM data but as encoded data. In an encoded state, the data is compressed.

When the received and transmission audio signals data are reproduced, decoding is executed in units of frames (one frame is one unit, e.g., 20 ms), and the decoded audio signals data are temporarily stored in a buffer. Thus, the received and transmission audio signals data are decoded in a time-division manner, using one decoder. This process is equivalent to a process using two decoders.

The decoded received and transmission audio signals data are added and output in accordance with the time information assumed when the stored data in the memory were encoded. In other words, if the audio output signal is not stereo sound signal but mono sound signal, synchronous reproduction of received and transmission voices can be realized using a single decoder, by adding PCM signals resulting from the decoding process, and outputting the added signal.

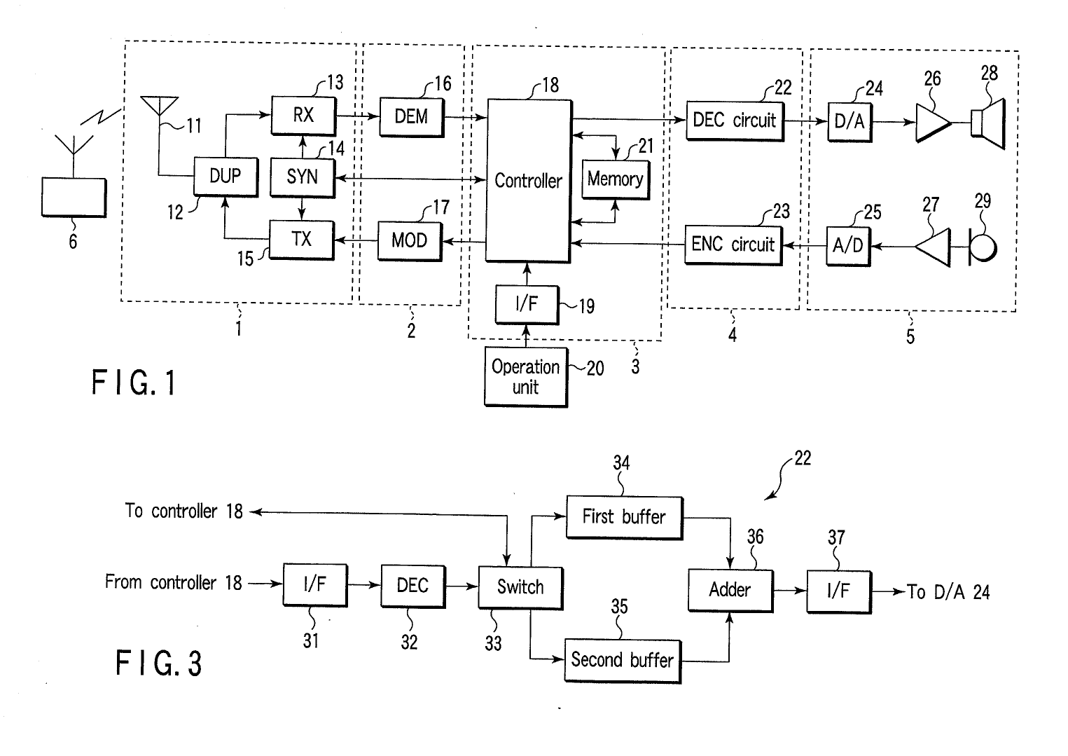

Referring to FIGS. 1 to 5, an audio-data recording/reproducing apparatus according to a first embodiment will be described. FIG. 1 shows electrical connections in the audio-data recording/reproducing apparatus.

In FIG. 1, a radio frequency signal, which is transmitted from a base station over radio channels for a mobile communication system, is received by an antenna 11 and is then input to a receiving circuit (RX) 13 via a duplexer (DUP) 12. The receiving circuit 13 includes a low-noise amplifier and a frequency converter. The received radio frequency signal is subjected to low-noise amplification by the low-noise amplifier.

Subsequently, the low-noise amplified radio frequency signal is supplied to the frequency converter, where the low-noise amplified radio frequency signal is mixed with a received local oscillation signal generated by a frequency synthesizer (SYN) 14, whereby the low-noise amplified radio frequency signal is converted, by frequency conversion, into a received intermediate-frequency signal or received baseband signal, and is output to a baseband modulator/demodulator 2.

In the baseband modulator/demodulator 2, the signal is digitally demodulated by a demodulator (DEM) 16. For this demodulation, orthogonal demodulation corresponding to the QPSK (Quadrature Phase Shift Keying) system is used, for example.

A controller 18 provided in a baseband control section 3 controls the frequency of the received local oscillation signal generated by the frequency synthesizer (SYN) 14. The demodulated signal output from the demodulator 16 is input to the controller 18.

The baseband control section 3 comprises the controller 18, a memory 21, and an interface (I/F) 19 for supplying the controller 18 with a signal output from an operation unit 20. The interface 19 is used by a user to record or reproduce a received or transmission audio signal.

The signal from the operation unit 20 determines whether or not the encoded received audio signal data as the demodulation signal data is to be stored in the memory 21. If the audio signal data is to be stored, the controller 18 commands to store the encoded received audio signal in a predetermined received-signal-storage portion of the memory 21. The received audio signal is stored in units of frames.

At the same time as the storage operation, the encoded received audio signal is output to a speech codec 4, where the encoded received audio signal is decoded into a PCM signal by a decoder (DEC circuit) 22 incorporated in the speech codec 4.

This PCM signal is output to a D/A converter (digital-to-analog converter) 24, where the PCM signal is converted into an analog audio signal. This audio signal is amplified to a predetermined level by an amplifier 26, and is output from a loudspeaker 28. Thus, the user who is now using the mobile radio communication apparatus can hear the received voice while recording the received voice.

On the other hand, the voice of the user as a transmission voice is input to a microphone 29 in an I/O (Input/Output) section 5. The microphone 29 outputs a transmission audio signal, which is amplified by an amplifier 27 to a predetermined level. The amplified signal is output to an A/D converter (analog-to-digital converter) 25, where the amplified signal is converted into a PCM signal.

An encoder (ENC circuit) 23 incorporated in the speech codec 4 encodes the PCM signal into an encoded transmission audio signal. The encoded transmission audio signal is output as frame data to the controller 18.

The encoder 23 divides the PCM signal, as an input audio signal, into components each having a predetermined length called a “frame”, analyzes sound in each frame, and converts each frame into several-tens to several-hundreds of bits of data. Generally, one frame is 20 ms. When the user has operated the operation unit 20 to instruct the apparatus to record the data, the data is accumulated in units of frames in the memory 21. The data of the received and transmission speech is synchronously stored in the memory 21.

The encoded transmission audio signal is input from the controller 18 to a modulator (MOD) 17 incorporated in the baseband modulator/demodulator 2, where the signal is digitally modulated. The modulated signal is supplied to a transmitter circuit (TX) 15. The QPSK method is used as the modulation method, for example.

The transmitter circuit 15 includes a frequency converter and a transmission power amplifier. The digitally modulated encoded transmission audio signal is supplied to the frequency converter, where the digitally modulated encoded transmission audio signal is frequency-converted into a radio frequency signal, more specifically, the digitally modulated encoded transmission audio signal is mixed with a transmission local oscillation signal generated by the frequency synthesizer 14. The thus-produced transmission radio frequency signal is amplified by the transmission power amplifier to a predetermined level, then the amplified signal is supplied to the antenna 11 via the duplexer 12, and the supplied signal is transmitted to a base station 6.

The power supply section (not shown) of the apparatus comprises a battery such as a lithium ion battery, a charger circuit for charging the battery, and a voltage generation circuit. The voltage generation circuit is formed of, for example, a DC/DC converter, and generates a predetermined power supply voltage based on the output voltage of the battery.

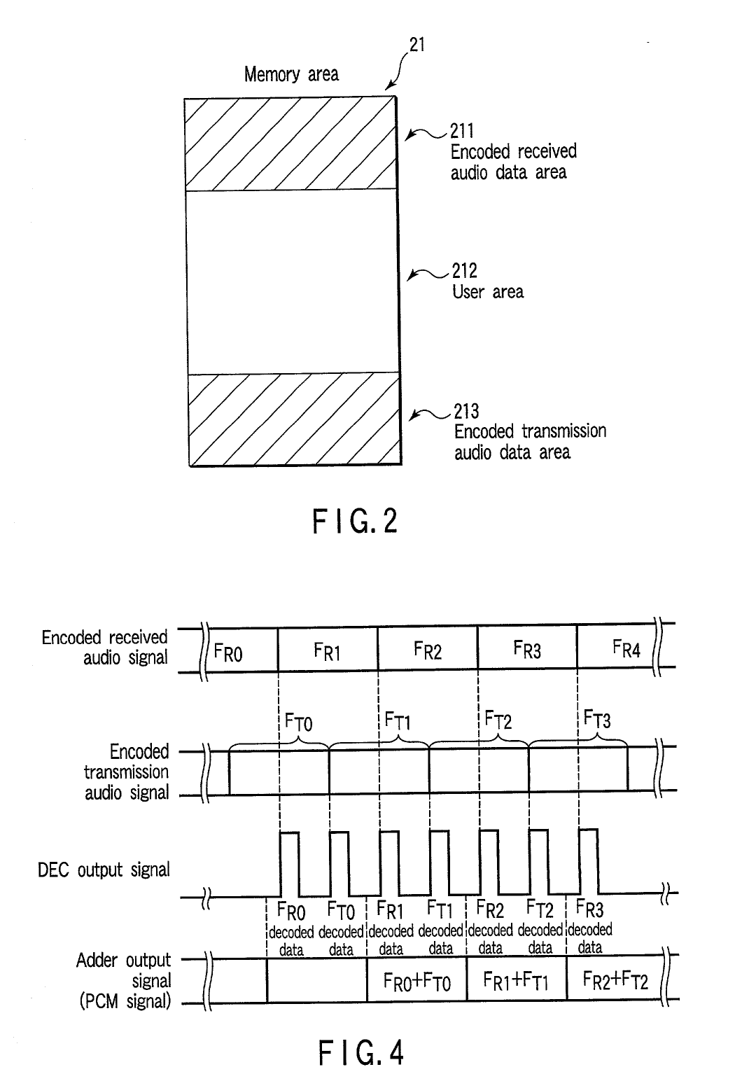

FIG. 2 schematically illustrates the memory area of the memory 21, which is divided into an area for encoded received audio data 211, a user area 212, and an area for encoded transmission audio data 213.

The memory 21 stores the data of encoded audio signals as described above. Specifically, encoded received and transmission audio signals are stored as data. When storing these signals data, audio signals simultaneously or synchronously transmitted and received are synchronously stored.

In other words, encoded received and transmission audio signals are synchronously stored in the memory 21. The storage is controlled in units of frames, and hence the audio signals data in the memory 21 are digitized in units of frames.

Generally, one frame is a period of 20 ms. Supposing that the encoding rate is 9600 bps (bits per second), one frame can contain 192 bits (24 bytes) as well as time information.

When a transmission audio signal data is stored in the memory 21, the transmission audio signal data is first encoded by the encoder 23 and then input to the memory 21 via the controller 18. On the other hand, when a received audio signal data is stored in the memory 21, the received audio signal data is first demodulated by the demodulator 16 and then input to the memory 21 via the controller 18.

Thus, the encoded transmission and received audio signals data are subjected to different processes before they are stored in the memory 21. Further, in general, signal encoding entails a greater number of processing steps and hence requires more time than decoding. Therefore, it is possible that the time interval between the transmission and received audio signals data stored in the memory 21 differs from the time interval between the actual transmission and received speech.

To eliminate this problem, it is necessary to store the transmission and received audio signals data in the memory 21 with information of the time required for the processing executed in the demodulator 16 and the time required for the processing executed in the encoder 23. Alternatively, it is sufficient if the reproduction start timings of the transmission and received audio signals data are adjusted at the time the transmission and received audio signals data are read from the memory 21 and decoded for reproduction. Specifically, the time adjustment may be executed, as described later, using first and second buffers 34 and 35 incorporated in the decoder 22.

Further, when the received or transmission audio signal data is stored in the memory 21, a frame number assigned to each frame may be stored in the memory 21, together with the audio signal data. In this case, the signal data can be reproduced, beginning from a frame number selected. For example, the user selects a frame number by operating, for example, an operation button of the operation section 20, whereby the reproduction of the audio signal data is started, beginning from the selected frame number.

In addition, the memory 21 may be set such that the user can refer to, for example, a date and time, at which each frame of an audio signal has been recorded, in relation to the number assigned to each frame. Furthermore, the memory 21 may be set such that the user can assign a name to a predetermined frame number. In this case, after the user assigns a name, audio signals can be reproduced based on this name.

FIG. 3 shows electrical connections in the decoder 22. FIG. 4 shows that the encoded received and transmission audio signals data are decoded, then the decoded signals data are added.

In FIG. 4, the uppermost signal sequence indicates an encoded received audio signal, and more particularly, indicates data in each frame. The second signal sequence indicates an encoded transmission audio signal, and more particularly, indicates data in each frame.

Further, the third signal sequence indicates a decoder (DEC) 32 output signal, and more particularly, indicates that data of each frame of the top and second signal sequences has been decoded. The lowermost signal sequence indicates a signal (PCM signal) output from an adder 36. More particularly, it indicates that data of each frame of the added decoded received and transmission audio signals (DEC outputs) is added and output as a PCM signal.

The decoder 32 shown in FIG. 3 decodes the encoded received and transmission audio signals data supplied via the memory 21 and controller 18. The decoded received and transmission signals are added and output. The controller 18 supplies, alternately, to an interface (I/F) 31, data of each frame of the encoded received and transmission audio signals, after the user has started the recording of the signals.

As indicated by the DEC output signal of FIG. 4, at first, the first frame data (FR1) of the encoded received audio signal is decoded by a decoder (DEC) 32 and output to a switch 33. When the encoded received audio signal data is decoded, the switch 33 is controlled by the controller 18 so that the output signal is output to a first buffer 34.

After that, the first frame data (FT1) of the encoded transmission audio signal is decoded by the decoder (DEC) 32 and output to the switch 33, as indicated by the signal sequence of the DEC output shown in FIG. 4. When the encoded transmission audio signal data is decoded, the switch 33 is controlled by the controller 18 so that the output signal is output to a second buffer 35.

The decoded frame data items (FR1) and (FT1) are simultaneously output from the first and second buffers 34 and 35, respectively. As indicated by the adder output signal of FIG. 4, the output first frame data items (FR1) and (FT1) are input to an adder 36 and then added.

The adder 36 outputs, as one frame data (FR1+FT1), the added data of the decoded data (FR1) and (FT1), and supplies the added data to an interface 37.

Thus, audio signals received and transmitted synchronously can be synchronously reproduced. Thereafter, the second et seq. frames are subjected to the same processing as the first frames. In other words, the second et seq. frames of the received and transmission audio signals are added in frame number order.

There are several methods for controlling the switch 33. To control the switch 33, for example, a counter for counting the number of frames is provided for the controller 18, and the count value of the counter is supplied to the switch 33.

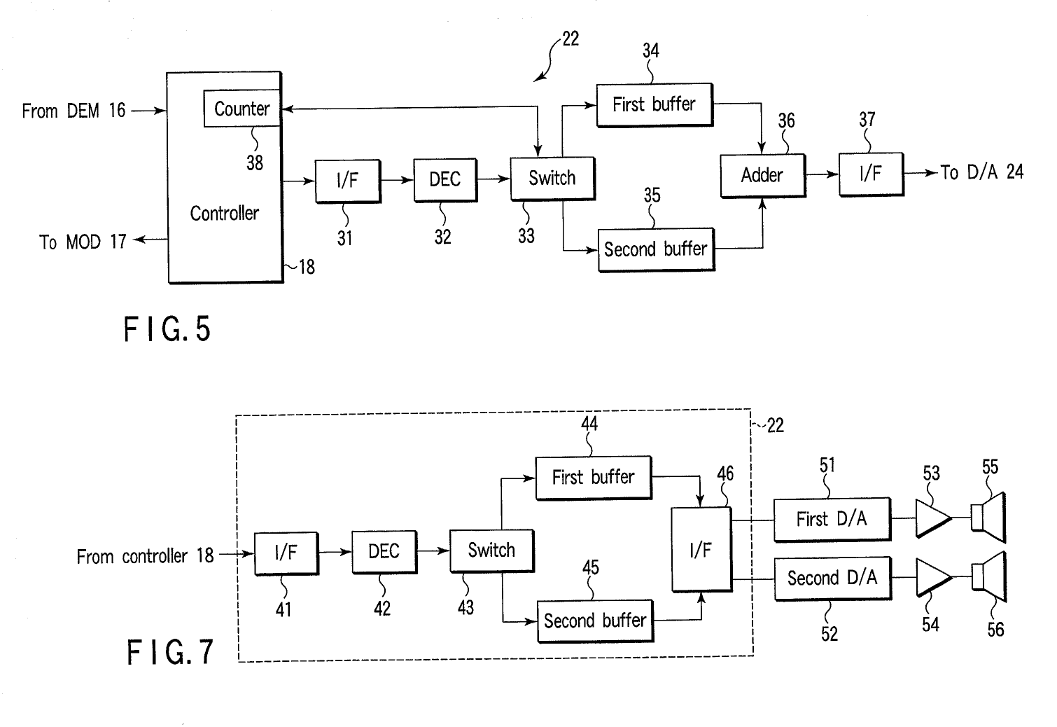

FIG. 5 is a block diagram illustrating electrical connections in the decoding circuit shown in FIG. 1, and the electrical connection between the decoding circuit and the counter of the control section. Specifically, a counter 38 is provided in the controller 18. The counter 38 counts the number of frames of audio signal data to thereby control the switch 33.

Alternatively, when the decoded N-th frame data (FRN; N=1, 2, . . . ) of the encoded received audio signal has been input to the switch 33, a signal indicating the input of the N-th frame data is output from the switch 33 to the controller 18. Upon receiving the signal indicative of the input of the N-th frame data, the controller 18 supplies the interface 31 with the N-th frame data (FTN) of the encoded transmission audio signal.

Subsequently, the decoder 32 decodes the data of the N-th frame of the encoded transmission audio signal, and outputs the decoded data to the switch 33, as in the case of the encoded received audio signal. The switch 33 executes switching to output the decoded N-th frame data to the second buffer 35.

Another method for controlling the switch 33 will be described. In this method, different marks are attached to the leading portions of the frames of the transmission and received audio signals data, before the signals are stored in the memory 21.

For example, data “0” is written to the leading portion of each frame of the transmission audio signal data, while data “1” is written to the leading portion of each frame of the received audio signal data. A detector for detecting the marks is provided before or after the decoder 32. The detection result is supplied to the switch 33, thereby causing the switch 33 to execute switching.

Alternatively, a frame number is also recorded at the leading portion of each frame, and the detected frame number is supplied to the switch 33 to control the switch 33.

After that, the N-th frame data (FRN) of the decoded received audio signal as a PCM signal is stored in the first buffer 34. Subsequently, the N-th frame data (FTN) of the decoded transmission audio signal as a PCM signal is stored in the second buffer 35. The adder 36 adds the output signals of the first and second buffers 34 and 35. These output signals indicate the frame data (FRN+FTN) of the PCM signal. The capacities of the buffers 34 and 35 are set such that the frame data items they handle can be synchronously or simultaneously input to the adder 36.

On the other hand, instead of alternately outputting the transmission and received audio signals data to the interface 31 in units of frames, the units may consist of a plurality of frames, for example all frames.

Specifically, several frames (e.g. one frame of each signal, i.e., two frames in total) of the transmission and received audio signals may be simultaneously output to the interface 31. Alternatively, complete to-be-reproduced transmission and received audio signals may be output at a time to the interface 31. In the above, the controller 18 controls the switch 33 on the basis of the number of frames output to the interface 31.

Furthermore, it is necessary to adjust the delay time between the first and second buffers 34 and 35 on the basis of the number of frames temporarily stored in the first and second buffers 34 and 35. This adjustment enables the adder 36 to synchronously or simultaneously reproduce the transmission and received audio signals data that were synchronously recorded.

Since the memory 21 stores the transmission and received audio signals data in different areas, it is easy for the transmission and received audio signals data to be individually reproduced. Further, it is easy for the user to reproduce one of the transmission and received audio signals data. In the case of reproducing only one of the transmission and received audio signals data, the apparatus is set to use only the one of the first and second buffers 34 and 35 that corresponds to the to-be-reproduced audio signal. In this case, it is not necessary for the output audio signal from the switch 33 to be switched between buffers.

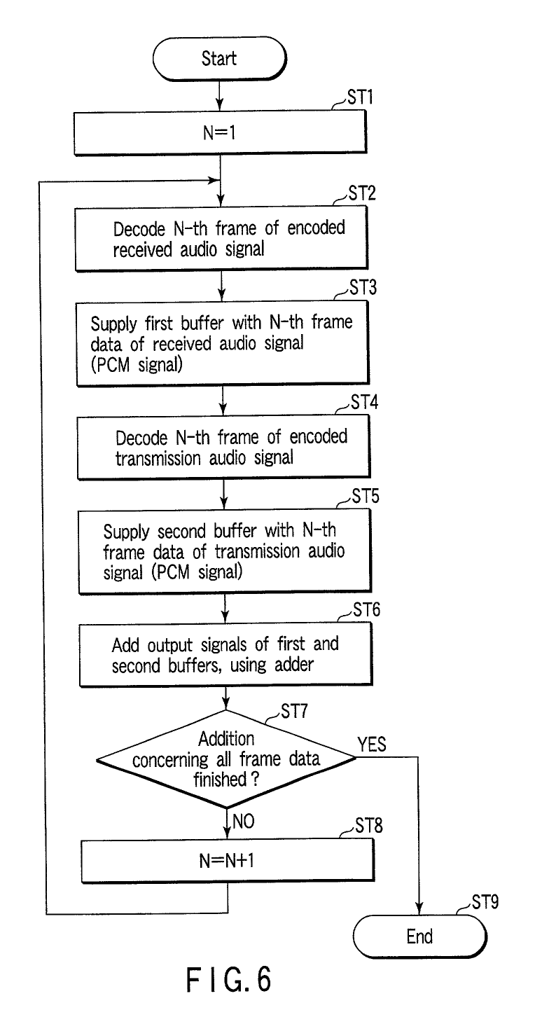

FIG. 6 is a flowchart useful in explaining the operation of the decoding circuit 22 in the decoding of the encoded received and transmission audio signals.

Firstly, the first frame data items of the encoded received and transmission audio signals data stored in the memory 21 are referred to (ST1).

The first frame data of the encoded received audio signal is output to the decoder 32, where the encoded received audio signal is decoded (ST2).

The switch 33 is controlled to output, to the first buffer 34, the first frame data of the decoded received audio signal (i.e., the received PCM signal) (ST3).

Subsequently, the first frame data of the encoded transmission audio signal is output to the decoder 32, where the encoded transmission audio signal data is decoded (ST4).

The switch 33 is controlled to output, to the second buffer 35, the first frame data of the decoded transmission audio signal (i.e., the transmission PCM signal) (ST5).

The time difference between the first frames of the received and transmission audio signals is adjusted between the first and second buffers 34 and 35. The first frame data items of the received and transmission audio signals output from the first and second buffers 34 and 35, respectively, are simultaneously output to the adder 36, where the first frame data items of the received audio signals and the first frame data items of the transmission audio signals are added (ST6).

Thereafter, the controller 18 determines whether or not addition has been executed on all frame data items to be reproduced (ST7). If addition and reproduction has been executed on all the frame data items, the program proceeds to a step ST9, thereby finishing the decoding process. If, on the other hand, the memory 21 still stores frame data items to be added, the program proceeds to a step ST8.

At the step ST8, the frame number is incremented. Specifically, immediately after the first frame data is decoded, the second frame data is subjected to the decoding process. Generally speaking, immediately after the N-th frame data is decoded, the (N+1)th frame data is subjected to the decoding process. N is a natural number, i.e., N=1, 2, 3. . . .

Thus, the encoded audio data stored in the memory 21 is decoded. Further, as described above, the number of frames that are decoded at a time can be optionally set. In this case, it is sufficient if the N-th frame in FIG. 6 is changed to the N-th packet (one packet is formed by a predetermined number of frames).

Referring to FIG. 7, an audio-data recording/reproducing apparatus according to a second embodiment of the invention will be described. FIG. 7 shows electrical connections of a decoding circuit, digital/analog converter, amplifier and loudspeaker employed in the second embodiment.

The circuit of FIG. 7 differs from the first embodiment in the structure including the adder 36 and the following. Specifically, in the second embodiment, the adder 36 shown in FIG. 3 is not used, and an interface (I/F) 46 is provided for inputting received and transmission audio signals output from first and second buffers 44 and 45, respectively.

First and second D/A converters 51 and 52 convert, into analog signals, the received and transmission audio signals output via the interface 46, respectively.

After that, the analog signals are output to loudspeakers 55 and 56 via amplifiers 53 and 54, respectively. As a result, received and transmission speech is output from the loudspeakers 55 and 56, respectively.

As a modification of the second embodiment, the circuit of FIG. 7 may be used to reproduce stereo sound. In this case, it is sufficient if left-channel signal data is stored in the same memory area as encoded received audio signals data are stored, while right-channel signal data is stored in the same memory area as encoded transmission audio signals data are stored.

The controller 18 controls the left-channel and right-channel signals data so that the left-channel and right-channel signals data are stored in the respective memory areas. As a result, these channel signals are reproduced in the same manner as the above-described received and transmission audio signals, whereby the above-described received and transmission audio signals are output from the loudspeakers 55 and 56 as stereo sound.

To record stereo sound, it may be downloaded from a base station 6 to the memory 21, as in received voice recording. Two microphones, similar to microphone 29 used in the first embodiment, may be provided for right and left channels. If so, sound is sampled in stereo, and transmission audio signal data is stored in the memory 21 in the same way as described above.

The audio-data recording/reproducing apparatus according to the embodiments enable the manufacture, at almost the same cost as in the prior art, of a mobile radio communication apparatus that can synchronously or simultaneously reproduce recorded transmission and received audio signal data.

Further, since transmission and received audio signal data is encoded and stored, the memory capacity can be effectively used, which enables storage of a great amount of audio data.

In addition, encoded transmission and received audio signals are decoded in a time division manner and are output simultaneously, whereby simultaneous reproduction of transmission and received speech can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An apparatus for recording and reproducing audio signal data used in a mobile radio communication apparatus for communicating with a base station, comprising:
a memory configured to synchronously store received and transmission signal data in compressed form in different areas; and
a decoding unit configured to decode the received and transmission signals data retrieved from the memory, and adjust reproducing timings of the received and transmission signal data.

2. The apparatus according to claim 1, wherein the received and transmission signals data are alternately output to the decoding unit in units of frames.

3. The apparatus according to claim 1, wherein the memory stores the received and transmission signals data in compressed form on the basis of a time period required for demodulating the received audio signal data, and a time period required for encoding the transmission audio signal data.

4. The apparatus according to claim 1, wherein the decoding unit includes:
a decoder configured to decode the received and transmission signals data;
a first buffer configured to temporarily store the decoded received audio signal data;
a second buffer configured to temporarily store the decoded transmission audio signal data; and
an interface configured to output the decoded received and transmission audio signals data output from the first and second buffers;
wherein the decoded received and transmission audio signals data being output from the first and second buffers are associated with each other.

5. The apparatus according to claim 4, wherein the decoding unit also includes a switch configured to output the decoded received and transmission audio signals data to the first and second buffers, respectively, the switch detecting whether signal data output from the decoder is the compressed received signal data or the compressed transmission signal data, and distributing the detected signal data to a corresponding one of the first and second buffers.

6. The apparatus according to claim 5, further comprising a counter configured to count a number of frames to be input to the decoding unit and output the counted number of frames to the switch, the switch detecting whether the signal data output from the decoder is the compressed received signal data or the compressed transmission signal data on the basis of the counted number of frames.

7. The apparatus according to claim 5, further comprising:
an assigning unit configured to assign a mark to the compressed received signal data when the compressed received signal data is stored, assign another mark to the compressed transmission signal data when the compressed transmission signal data is stored; and
a detector configured to detect each of the marks and determine which one of the compressed received and transmission signals data has been output;
wherein the switch detects whether the signal data output from the decoder is the compressed received signal data or the compressed transmission signal data on the basis of the assigned mark.

8. The apparatus according to claim 4, further comprising an adder configured to add the decoded received and transmission audio signals data output from the first and second buffers and output the added data to the interface, the adder adding the decoded received and transmission audio signals data in units of sampling data.

9. The apparatus according to claim 8, wherein the first and second buffers have their capacities set such that the decoded received and transmission audio signals data output from the first and second buffers are simultaneously input to the adder.

10. The apparatus according to claim 8, wherein timings for outputting the decoded received and transmission audio signals data from the first and second buffers are adjusted on the basis of synchronous information concerning the compressed received and transmission signals data stored in the memory.

11. The apparatus according to claim 4, further comprising:
a first loudspeaker configured to output received voice corresponding to the decoded received audio signal data supplied from the first buffer via the interface; and
a second loudspeaker configured to output transmission voice corresponding to the decoded transmission audio signal data supplied from the second buffer via the interface.

12. The apparatus according to claim 11, wherein one of the received and transmission voices is processed via a left channel, and the other of the received and transmission voices is processed via a right channel.

13. The apparatus according to claim 11, wherein the compressed received signal data corresponds to one of left-channel and right-channel signal components of a received stereo signal data, and the compressed transmission signal corresponds to the other of the left-channel and right-channel signal components of the received stereo signal data.

14. The apparatus according to claim 11, further comprising a microphone configured to record in stereo, the compressed received signal data corresponding to a received signal data input to one of left-channel and right-channel of the microphone, and the compressed transmission signal data corresponding to a transmission signal data input to the other of the left-channel and right-channel of the microphone.

15. An apparatus for recording and reproducing audio signal data used in a mobile radio communication apparatus for communicating with a base station, comprising:
memory means for synchronously storing received and transmission signal data in compressed form in different areas; and
decoding means for decoding the received and transmission signals data retrieved from the memory, and adjusting reproducing timings of the received and transmission signal data.
